(19) United States
(12) Patent Application Publication
(10) Pub. No.: US 2016/0275578 A1
(43) Pub. Date: Sep. 22, 2016

(54) ENTERPRISE SYSTEM, METHOD AND COMPUTER PROGRAM PRODUCT FOR AGGREGATING AND PRO RATING EXPENSES ACROSS MEMBERS OF A NETWORKED VIRTUAL COLLECTIVE

(71) Applicant: Christopher Amundsen, North Salt Lake, UT (US)

(72) Inventor: Christopher Amundsen, North Salt Lake, UT (US)

(21) Appl. No.: 14/662,186

(22) Filed: Mar. 18, 2015

(51) Int. Cl. G06Q 30/06; G06Q 50/00; G06Q 20/14

(52) U.S. Cl. CPC G06Q 30/0605; G06Q 20/14; G06Q 50/01

(57) ABSTRACT

A computer program product, system and method are disclosed for aggregating expenses incurred by members of a group of commonly acquainted parties (the parties comprising individuals, entities, or organizations), and for collecting pro rated funds from each member. The parties are brought into communication by a computerized central managing forum, communicating via a network, which acts as a fiduciary of the parties and uses a uniquely configured data processing device which prompts the interconnected parties to remit pro rated payments of digitized bills stored and made digitally available by the central managing forum to the parties. Members network and generate pictures that are pertinent to products or services that benefit the collective. Merchants analyze personal information of members, and networking activity between members to provide discount offers accordingly. Additional embodiments of the invention include a uniquely configured classified listing service, and notification service for special consumer offers.

### CROSS REFERENCE TO RELATED APPLICATIONS

This application claims the benefit of U.S. nonprovisional application Ser. No. 13/171,219 and entitled ENTERPRISE SYSTEM, METHOD AND COMPUTER PROGRAM PRODUCT FOR AGGREGATING AND PRO RATING EXPENSES ACROSS MEMBERS OF A NETWORKED VIRTUAL COLLECTIVE, which nonprovisional application is incorporated by reference herein in its entirety.

### BACKGROUND OF THE INVENTION

1. Field of the Invention

This invention relates to online banking, and more particularly relates to a method, system and computer program product for managing, collecting and distributing expenses incurred by socially networked members of a group from one another, and facilitating efficient commercial transactions between them, including transaction arising from classified ads and discount coupon offers.

2. Description of the Related Art

Recent developments in the industry of banking and classified advertising include business models such as eBay®, PayPal®, FaceBook®, and Groupon®. Each of the websites managed by these organizations bring networked individuals into contact with another for the purpose of marketing goods and/or services, and/or effectuating financial transactions between them.

Although developments in the art teach means of billing and collecting debts incurred by consumers in commercial transactions, these developments do not teach efficient means of billing commonly-acquainted, socially networked members of a group for their respective pro rata shares of expenses benefiting the group as a whole, nor do presently existing models teach means of facilitating the reimbursement of expenses fronted by one individual of group from associated third-parties.

Furthermore, those online business that archive searchable classified ads, and those that market time-limited discount offers, do not provide integrated means of effectuating payment for contracts made between consumers. Rather, these sites redirect consumers to third-party sites which handle the payment transfers, such as PayPal®.

There exists a need in the industry for a fully integrated model. The present invention discloses means of aggregating bills tendered to members of a group of commonly acquainted parties (the parties comprising individuals, entities, or organizations), then of billing and collecting pro rated funds from each member of the collective. Additional embodiments of the invention include a uniquely configured classified listing service, and notification service for special consumer offers.

### SUMMARY OF THE INVENTION

From the foregoing discussion, it should be apparent that a need exists for an enterprise system, method and computer program product for aggregating and pro rating expenses across members of a networked virtual collective. The present invention has been developed in response to the present state of the art; and, in particular, in response to the problems and needs in the art that have not yet been fully solved by currently available methods, systems and apparatus, and that overcome many or all of the above-discussed shortcomings in the art. Accordingly, the present invention has been developed to provide an enterprise system and computer program product for aggregating and pro rating expenses across members of a networked virtual collective.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

A computer program product, system and method are disclosed for aggregating expenses incurred by members of a group of commonly acquainted parties (the parties comprising individuals, entities, or organizations), and for collecting pro rated funds from each member. The parties are brought into communication by a computerized central managing forum, communicating via a network, which acts as a fiduciary of the parties and uses a uniquely configured data processing device which prompts the interconnected parties to remit pro rated payments of digitized bills stored and made digitally available by the central managing forum to the parties. Members network and generate pictures that are pertinent to products or services that benefit the collective. Merchants analyze personal information of members, and networking activity between members to provide discount offers accordingly. Additional embodiments of the invention include a uniquely configured classified listing service, and notification service for special consumer offers.

The present invention discloses a computer program product comprising a computer readable medium having computer usable program code executable to perform operations for distributing expenses to a commonly-acquainted collective. The operations of the computer program product comprise: incorporating a plurality of members into a virtual collective by storing voluntarily uploaded personal information for each member in computer readable memory, the personal information comprising one or more of name, email address, phone number, and banking information; receiving a payment request uploaded into computer readable memory from one member of the collective for an expense via a network; generating one or more of a picture that is pertinent to the expense via the wireless network, the pertinent picture uploaded into computer readable memory from one member of the collective for the expense incurred for the benefit of the collective; and dividing the expense pro rata among the members of the collective.

The operations further comprise prompting electronically via the network each member of the collective to pay a pro rata share of the expense; sending a virtual bill via email to each member of the collective; networking among the members of the collective to review the expense and the pertinent picture;

The operations further comprise receiving an electronic payment of a pro rata share from each of a plurality of the members of the collective; maintaining a running tally of payment amounts received from members of the collective; notifying each member via the network of the collective of the gross total of collective payments received which are associated with the expense; reminding non-paying members of the user group to pay.

The operations further comprise analyzing, by a merchant, the voluntarily uploaded personal information for each member, and the networking interactions among the members; and providing a discount offer to the paying members based on the analysis.

In some embodiments, the operations further comprise remitting all payments received and associated with the expense to the member uploading the payment request. In still further embodiments, the operations further comprise creating a sub-collective comprising a plurality of the members, each of the members of the sub-collective associated with one of: a common commercial venture and a common recreational activity.

In other embodiments, the operations further comprise maintaining a banking account balance for each member of the collective, the balance exclusively accessible by a member of the collective associated with the balance.

In some embodiments, the network comprises a wireless cellular network, while in other embodiments, each of the members are notified via one of computer terminal and a smart cellular phone.

In additional embodiments, the operations further comprise receiving a classified ad from a member via an upload, the classified ad comprising one or more of a picture of a tangible good and contact information for the member, the contact information comprising one or more of name, email address, and telephone number; providing a searchable database of all classified ads received by members; and facilitating the transfer of money between the member uploading the classified ad and a purchaser.

In still further embodiments, the operations further comprise: receiving a discount offer via an upload from a member, the discount offer comprising one or more of an offer to sell a consumer good exclusively to members, the offer comprising a price that is less than a price charged to non-members, the price exclusively available to members; allowing members to purchase the consumer good for the price; and transferring money from a member buying the consumer good to a member responsible for the upload.

In some embodiments, each of the members may be assigned a pay percentage value, the pay percentage value identifying the percentage of the expense for which each respective member is responsible.

A system to perform operations for distributing expenses to a commonly-acquainted collective is also disclosed, the system comprising: a processor; a data storage means for storing data; an incorporator module configured to incorporate a plurality of members into a virtual collective by storing voluntarily uploaded personal information for each member in computer readable memory, the personal information comprising one or more of name, email address, phone number, and banking information; a receiver module configured to receive a payment request uploaded into computer readable memory from one member of the collective for an expense via a network; and a divider module configured to divide the expense pro rata among the members of the collective.

The system further comprises a prompter module configured to prompt electronically via the network each member of the collective to pay a pro rata share of the expense; a payer module configured to receive an electronic payment of a pro rata share from each of a plurality of the members of the collective; a maintainer module configured to maintain a running tally of payment amounts received from members of the collective; a notifier module configured to notify each member via the network of the collective of the gross total of collective payments received which are associated with the expense; and a reminder module configured to remind non-paying members of the user group to pay.

The system may also comprise a remitter module configured to remit all payments received and associated with the expense to the member uploading the payment request.

The system may additionally comprise a creator module configured to create a sub-collective comprising a plurality of the members, each of the members of the sub-collective associated with one of: a common commercial venture and a common recreational activity.

The network may comprise a wireless cellular network. Each of the members may be notified via one of computer terminal and a smart cellular phone.

The system may further comprise: an ad module configured to receive a classified ad from a member via an upload, the classified ad comprising one or more of a picture of a tangible good and contact information for the member, the contact information comprising one or more of name, email address, and telephone number; a provider module configured to provide a searchable database of all classified ads received by members; and a facilitator module configured to facilitate the transfer of money between the member uploading the classified ad and a purchaser.

The system may further comprise: an offer module configured to receive a discount offer via an upload from a member, the discount offer comprising one or more of an offer to sell a consumer good exclusively to members, the offer comprising a price that is less than a price charged to non-members, the price exclusively available to members; an allower module configured to allow members to purchase the consumer good for the price; and a money module configured to transfer money from a member buying the consumer good to a member responsible for the upload.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an entity-relationship diagram illustrating one embodiment of a system to perform operations for distributing expenses to commonly-acquainted members of a collective in accordance with the present invention;

FIG. 2 is an entity-relationship diagram illustrating one embodiment of a system to perform operations for distributing expenses to commonly-acquainted members of collective in accordance with the present invention;

FIG. 3 is a flowchart illustrating one method for distributing expenses to commonly-acquainted members of a collective in accordance with the present invention;

FIG. 4 is a block diagram illustrating components of one embodiment of an apparatus for distributing expenses to commonly-acquainted members of a collective; and

FIG. 6 is a layout of browser manipulated by one embodiment of the present invention for distributing expenses to commonly-acquainted members of a collective in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention. The apparatus modules recited in the claims may be configured to impart the recited functionality to the apparatus.

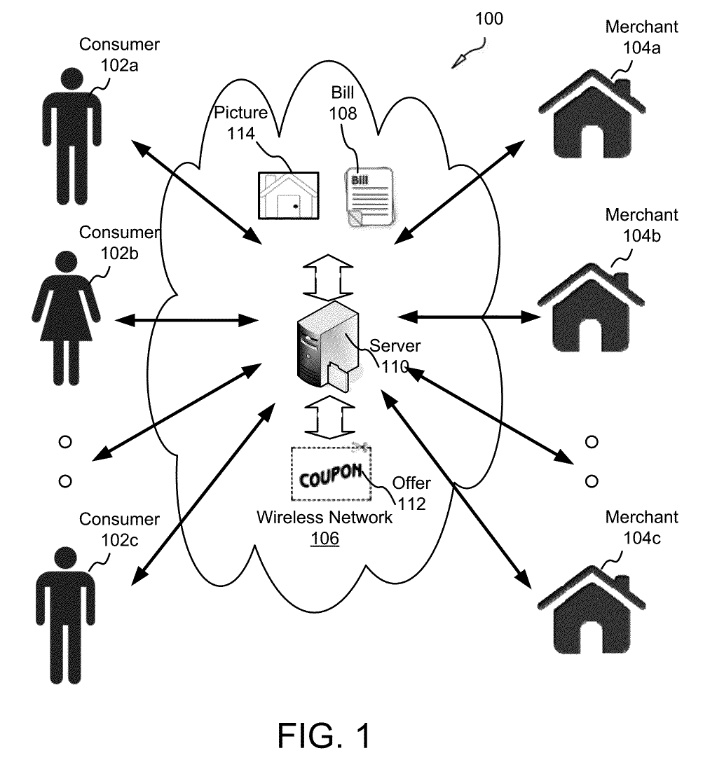

FIG. 1 is an entity-relationship diagram illustrating one embodiment of a system 100 to perform operations for distributing expenses to commonly-acquainted members of a collective in accordance with the present invention. The entities in the system 100 comprise consumers 102a-c, merchants 104a-c, a wireless network 106, a bill 108, and a server 110.

The server 110 comprises a system or computer program running on one or more data processing devices (DPDs), such as a server, computer workstation, router, mainframe computer, or the like. In various embodiments, the DPD comprises one or more processors. The processor is a computing device well-known to those in the art and may include an application-specific integrated circuit (“ASIC”).

The server 110, in the shown embodiment, comprises a database management system (DBMS) or relational database management system (RDBMS), such as Oracle, SQL, FireBird, IBM DB2®, or the like. In the shown embodiment, one or more individuals access or login to an account they have with the server 110. These individuals upload personal identifying information which they use to create an account with the server 110, which account membership information is stored in computer readable database memory accessible by server 110.

The personal identifying information is stored in a database; and comprises identifying information, such as name, address, email, telephone, IP address information, age, address, gender, banking information, credit rating, email, telephone number, income, and education.

In the present invention, the server 110 interconnects one or more members 102 and/or merchants 104 through means known to those of skill in the art, including a website accessible over a wireless network 106 such as the Internet.

The server 110 may, in typical embodiments, be in logical communication with consumers 102 through a networked environment, such as local area network (LAN) or wide area network (WAN).

It is an object of the present invention to provide means for consumers 102 to share expenses incurred by a group (i.e. collective) of which they form part, which expenses are incurred by, or benefit, the collective as a whole. For instance, consumers 102 belonging to a family unit vacationing out of town may wish to share expenses across the family unit. Likewise friends vacationing may wish to do the same. Co-owners of a home may wish to split a home payment, and tenants may wish to split a mortgage or lease payment, either pro rata or non-pro rata. In yet another example, members 102 sharing a meal may wish to split the cost of the meal immediately at the table pro rata.

In essence, members 102 may easily build a safe social payment network 106 to pay and collect money from friends and family in the network 106 in real time and on a mobile platform. The members 102 may communicate readily with each other to split payments, discuss products and services, approve and disapprove transactions, and check on their transaction history. An integrated web browser also allows the members 102 to share links and propose group activities.

In accordance with the present invention, each of the members 102a-c of a collective of commonly-acquainted consumers 102a-c may pay only their share of an expense incurred by the collective using the method, system and computer program product recited below. In one embodiment, the computer program product (which comprises a computer readable medium having computer usable program code that is executable) performs operations for distributing expenses to a commonly-acquainted collective. The operations of the computer program product comprise, in some embodiments, incorporating a plurality of members 102a-c into a virtual collective by storing voluntarily uploaded personal information for each member 102 in computer readable memory, the personal information comprising one or more of name, email address, phone number, and banking information.

Consumers 102 become “incorporated” after registering with the server 110 and provided personal identifying information thereto, including one or more of name, email address, banking routing number, bank account number, IP address, and the like.

In the shown embodiments, once a consumer 102 has been incorporated by the server 110, the consumer 102 may be prompted to join of collective. Consumers 102 may search for collectives by name, or start a new collective and invite acquaintances by name to join. These acquaintances may comprise personal and professional acquaintances with whom the consumer 102 maintains personal and/or professional relationships. The consumer 102 is thus first incorporated, then joined into a collective, before being able to share expenses incurred by the collective.

The consumers 102 may also be in communication with each other through the wireless network 106. Through the network 106, the consumers 102 may discuss, review, and share information pertinent to expenses incurred by a group (i.e. collective) of which they form part, which expenses are incurred by, or benefit, the collective as a whole.

Incorporated consumers 102 (i.e. members) are brought into social contact with one another. These incorporated consumers 102 can chat with one another using means known to those of skill in the art. These consumers 102 can message one another using email via means known to those of skill in the art, and these members 102a can notify other members 102b of their collective of special offers 112 on tangible consumer goods for sale, and/or their willingness to pay expenses about to be incurred by the collective via the actions of one or members 102b of the collective.

The consumers 102 communicate in the wireless network 106 using data processing devices (DPDs), which, in the preferred embodiment, comprise smart phones including iPhone, Android, Palm Pilots®, and the like. These DPDs may even comprise digital cameras or laptops, etc.

Consumers 102, in some embodiments, may upload, or transfer, discount offers 112 and/or classified ads and/or money transfer orders to the server 110. The consumers 102 may make these uploading, or transfer these instructions, using means known to those of skill in the art, including variations of the Simple Mail Transfer Protocol (SMTP), Internet Message Access Protocol (IMAP), Post Office Protocol (POP), File Transfer Protocol (FTP), or other protocols.

Consumers 102, in some embodiments, may generate one or more of a picture 114 that is pertinent to the expense incurred by the group. The picture 114 may be shared on the network 106. Those skilled in the art, will recognize that visualization of as products and services shared by the group of consumers 102a-c, through the use of pictures 114 may help facilitate payment, as consumers 102 are visually reminded of the collective benefit. The pictures 14 may also be posted on the network 106 for other members 102b-c to view and comment on.

For example, without limitation, a member 102 may generate pictures 114 of a meal at a restaurant that is shared amongst the members 102 of the collective. The pictures 114 may include, without limitation, the members present at the meal, the food, the restaurant, and the bill. The means of generating the picture 114 may include, without limitation, a camera photo, a smartphone phot, a video, and a social network image capture.

In various embodiments, before incurring an expense for the collective, members 102 may upload a price and description of an expense about to be incurred. The consumers 102 may also upload the one or more picture 114 to help visualize what they are potentially paying for. In some embodiments, these consumers 102 also upload an estimated date, or durations of time, upon which the expense will be incurred.

In various embodiments, the members 102 of the collective then indicate their willingness to pay a share of this expense by pressing a virtual button on a smart phone or other DPD in communication with the server 110. In various embodiments, members 102 who do not indicate either a willingness to accept responsibility for the expense, or do not accept responsibility for the expense, are deemed by the server 110 to have consented or non-consented to the expense in accordance with either setting configured by an administrator or default settings saved in computer readable memory. In some embodiments, those members 102 who do not consent may not receive special benefits, as described below.

In various embodiments, the consumer 102 is prompted whenever an expense is uploaded a member of that consumer's 102 collective to pay a pro rata share. In other embodiments, each consumer 102 in the collective is exclusively assigned by the creator of the collective a pay percentage value, which comprises a value identifying the percentage of each expense for which each respective consumer 102 is responsible.

The server 110 may divide up a bill uploaded for payment by the collective into smaller bills which are tendered to each member 102 of the collective. These smaller bills may consist of payment amounts determined in accordance with each consumer's 102 pay percentage value, or may consist of a pro rated expense based on the number of consumers 102 in the collective.

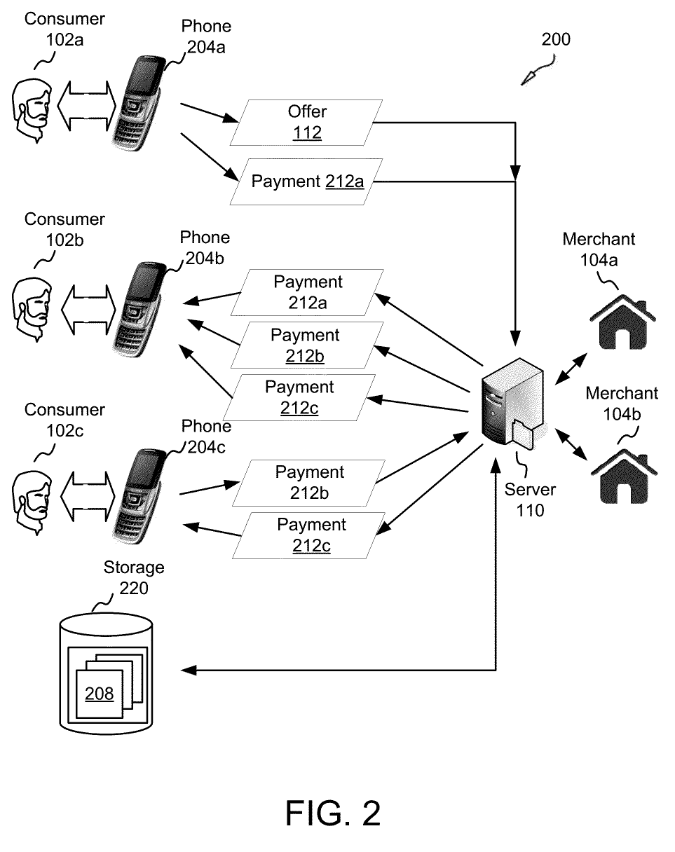

FIG. 2 is an entity-relationship diagram illustrating one embodiment of a system 200 to perform operations for distributing expenses to commonly-acquainted members of collective in accordance with the present invention. The system 200 comprises merchants 102a-c, phones 204a-c, an offer 210a, a payment 212a, a payments 212b, a payment 212c, and computer readable storage 220 comprising computer readable database records 208.

In the shown embodiment, merchants 104a-b, using DPDs, are in logical communication via a network with the server 110 and consumers 102a-c. Merchants 104 may likewise be incorporated by the server 110. The merchants 104 may comprise any individual, company or organization attempting to retail, sale, or market goods or services to consumers 102.

These consumers communicate with the server 110, in the shown embodiment, using smart cellular phones 204a-c. Using these phone 204a-c, the consumers 102a-c remit payments 212a-c to the server 110. In the shown embodiment, the server than remits, or reimburses, these payments 212a-c, to consumer 102b, who, in this embodiment, paid an original bill 108 for the collective.

Likewise, consumers 102 and merchants 104 may remit offers 112 to the server 110. These offers 112 may comprise offers on new or used goods, which are offered with exclusively to the members of the collective, or to all incorporated consumers 102.

Merchants 104 may desire to perform marketing functions directed towards the consumers 102 to determine eligibility for the offers 112. In some embodiments, merchants 104 may analyze the voluntarily uploaded personal information for each member 102, and the networking interactions among the members. The analysis may include any marketing research known in the art. The analysis enables merchant 104 to better understand buying and sharing patterns of consumer 102.

For example, the merchant 104 may recognize that consumers 102 who use Snapchat™ as their chief networking communication are younger than consumers 102 who use primarily Facebook™. The types and quantities of products and services used by each consumer 102 may also be parsed for information. Using this data, the merchant 104 provides discount offers 112, accordingly. Thus, merchant 104 provides offers 112 to consumers, at least partially based on the marketing analysis of consumers 102 and networking by consumers 102.

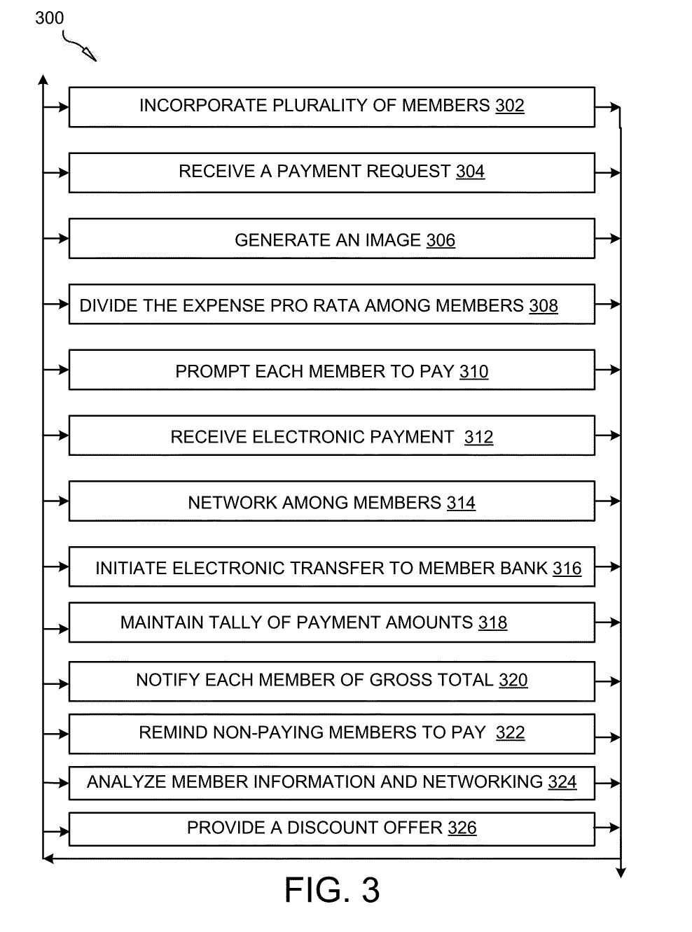

FIG. 3 is a flowchart illustrating one method 300 for distributing expenses to commonly-acquainted members of a collective in accordance with the present invention. The method 300 enables members 102 of a collective to share payment for a product or service that benefited the collective. The payments 212 are automated and may be pro rata to facilitate the method 300. The members 102 may also share and discuss the product, service, and payment 212 thereof through a wireless network 106, such as the Internet. The networking may include chats, one or more pictures 114, blogs, reviews, and testimonials. Merchants may also benefit, as the networking is used to analyzer the members 102, i.e., potential consumers, and provide a benefit accordingly.

The method 300 begins with a Step 302 when individuals are incorporated as members into the virtual collective. Consumers 102 become “incorporated” after registering with the server 110 and provided personal identifying information thereto, including one or more of name, email address, banking routing number, bank account number, IP address, and the like.

In Step 304, the method 300 enables receiving a payment request and a description of an expense via a wireless network, the payment request uploaded into computer readable memory from one member 102 of the collective for the expense incurred for the benefit of the collective. In one embodiment, bills 108 (i.e. payment requests), are received uploaded into computer readable memory from one member 102 of the collective for an expense via a network. The expense is for a product or service that benefits the collective.

In some embodiments, a Step 306 may include generating one or more of a picture 114 that is pertinent to the expense via the wireless network, the pertinent picture 114 uploaded into computer readable memory from one member 102 for access by the collective. The picture 114 may be generated by a camera in a communication device, such as a smart phone. The picture 114 can be shared on the network 106 and used to remind members 102b-c about the product or service that was shared. Additionally, reviews, comments, and comparisons are facilitated with the pictures 114.

In a Step 308, expenses are divided pro rata among the members of the collective. The server 110 may divide up a bill uploaded for payment by the collective into smaller bills which are tendered to each member 102 of the collective. These smaller bills may consist of payment amounts determined in accordance with each consumer's 102 pay percentage value, or may consist of a pro rated expense based on the number of consumers 102 in the collective.

Step 310 involves prompting each member 102 electronically via the network 106 each member 102 of the collective to pay a pro rata share of the expense. The reminders may include emails, phone calls, texts, and reminders form other members 102 on the network 106.

A Step 312 comprises sending a virtual bill 108 to each member 102. The bill 108 may be sent via email, mail, text, or automated bank withdrawal means.

In some embodiments, a Step 314 may include networking among the members 102a-c of the collective to review both the expense and the pertinent picture 114. Through the network 106, members 102 are brought into social contact with one another. The networking is key to maintaining a social responsibility between members 102 of the collective to better understand the products and services, and then make the required payments. For example, on the network 106, members 102a-c may share information, discuss the product or service, schedule get-togethers, and remind each other to make payments.

Furthermore, on the network 106, members 102 can chat with one another using means known to those of skill in the art. Members 102 can message one another using email via means known to those of skill in the art, and these members 102 can notify other members of their collective of special offers on tangible consumer goods for sale, and/or their willingness to pay expenses about to be incurred by the collective via the actions of one or members 102 of the collective.

A Step 316 includes receiving, by the server 110, an electronic payment of a pro rata share from each of a plurality of the members of the collective. Each consumer 102 in the collective is exclusively assigned by the creator of the collective a pay percentage value, which comprises a value identifying the percentage of each expense for which each respective consumer 102 is responsible.

The aforementioned Step 316 is performed simultaneously with a Step 318 of maintaining a running tally of payment amounts received from members of the collective. The server 110 calculates and assigns the payment amounts received, accordingly.

A Step 320 further includes the server 110 notifying each member 102 via the network 106 of the collective of the gross total of collective payments received which are associated with the expense.

A Step 322 may include reminding non-paying members 102 of the user group to pay. The reminders may include emails, phone calls, texts, and even friendly pokes from other members 102 on the network. In this manner, nonpaying members 102 may be encouraged to participate in their fiduciary obligations.

In various embodiments, the server 110 maintains virtual bank accounts exclusively associated with each member of the collective. These bank accounts contain a balance of virtual dollars, each virtual dollar exclusively corresponding to an actual dollar in a real bank account maintained by an administrator of the server 110. In one possible embodiment, members 102 can see each other's bank accounts. However, in other embodiments, members 102 can only access their own bank account.

A Step 324 comprises analyzing, by merchants 104a-c, the voluntarily uploaded personal information for each member 102a-c, and the networking interactions among the members 102a-c. Merchant 104 may desire to perform marketing functions directed towards the consumers 102 to determine eligibility for the offers 112.

In some embodiments, merchants 104 may analyze the voluntarily uploaded personal information for each consumer 102, and the networking interactions among the consumers 102. The analysis may include any marketing research known in the art. The analysis enables merchant 104 to better understand buying and sharing patterns of consumer 102.

A final Step 326 includes providing a discount offer 112 to the paying members 102 based on the analysis. Merchant 104 provides offers 112 to consumers 102, at least partially based on the marketing analysis of consumers 102 and networking efforts by consumers 102. In one embodiment, merchant 104 may be constrained to providing offers only to paying members.

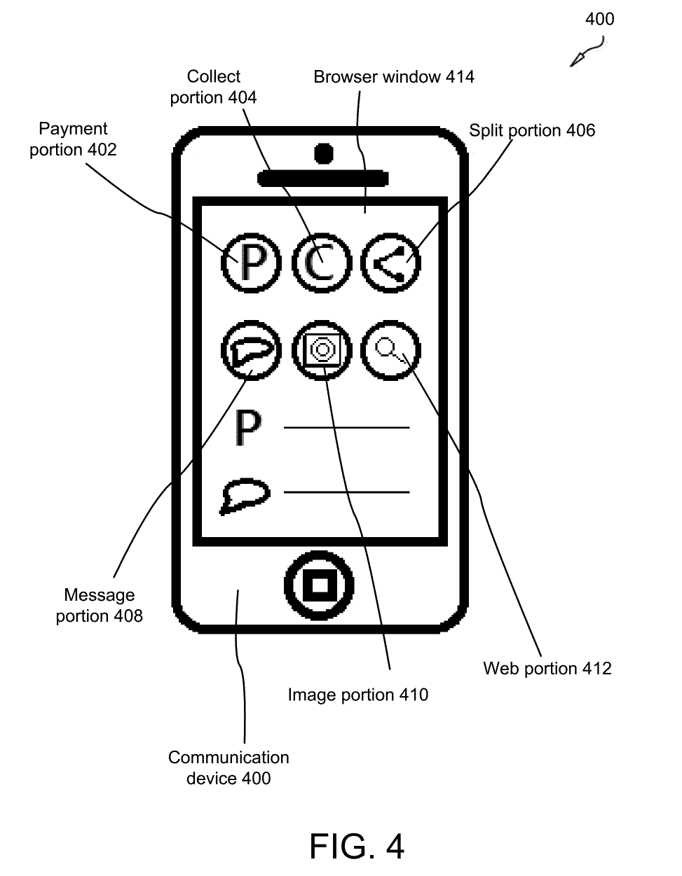

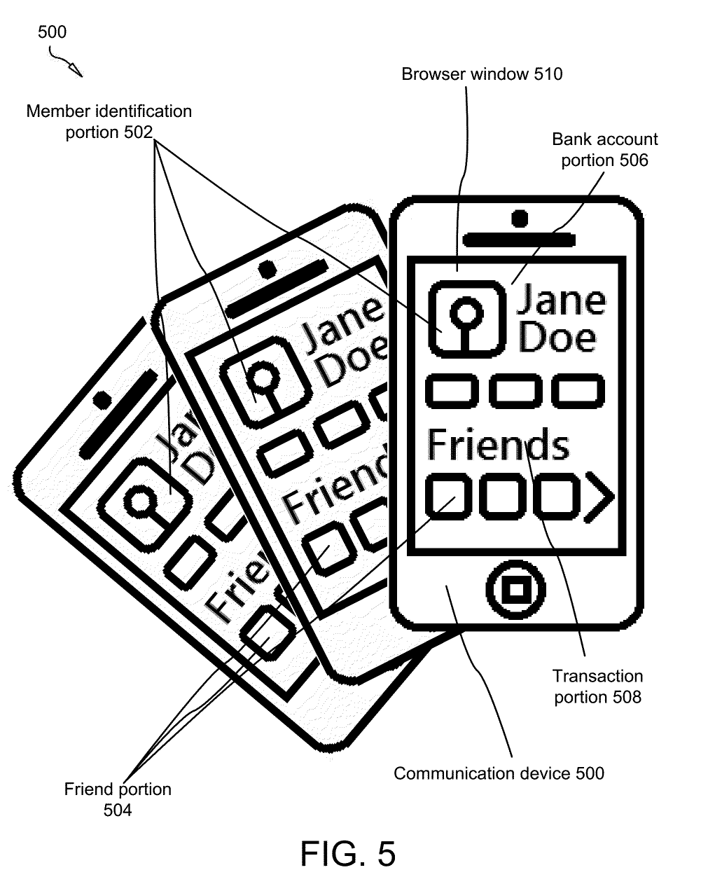

FIG. 4 is a layout of a browser window 414 on a communication device 400 manipulated by one embodiment of the present invention for distributing expenses to commonly-acquainted members of a collective in accordance with the present invention. The communication device 400 may include a smart phone, as viewed by member 102 of the collective. In one embodiment, the system 100, 200 may be downloadable on the communication device 400 as a software application.

Through the browser window 414, member 102 is provided access to most of the features offered by the system, including networking, payments, and reception of offers.

A payment portion 402 enables member 102 to make a payment for the collective product or service. The payment portion 402 may include a calculator or access to the server, to determine the correct share of payment for the member 102. The payment portion 402 may operatively connect to the bank account of the member for accessing the funds.

The account balance and transaction history in the bank account may also be accessible form the payment portion 402. Additional functional availability from the payment portion 402 may include, without limitation, viewing dates of transactions, uploading a bill 108, viewing transaction history, and itemizing transactions, i.e., food, travel, utilities, etc. A password may be required to access the payment portion 402.

A collect portion 404 enables a member 102a to collect payment from other members 102b for services or products exchanged. Members 102 can message one another using email via means known to those of skill in the art, and these members 102a can notify other members 102b of their collective of special offers on tangible consumer goods for sale, and/or their willingness to pay expenses about to be incurred by the collective via the actions of one or members 102b of the collective. The collect portion 404 enables payment between members 102a-b.

A split portion 406 enables the members 102 to split the payment for the product or service. Server 110 calculates and deducts for member bank accounts accordingly. In one embodiment, the split pro rata amount may be adjustable by members, as desired. The account balance and transaction history in the bank account may also be accessible form the split portion 406.

A message portion 408 enables members 102 to message each other before, during, and after payment is remitted. The messaging may also be efficacious for better understanding the product or service. Messaging through the message portion 408 forms a part of the cumulative networking capacities of the system 100, 200.

An image portion 410 enables consumers 102 to generate one or more of a picture 114 that is pertinent to the expense incurred by the group. The picture 114 may be generate don a camera on the communication device 400. The picture 114 may be shared on the network 106 for other members 102b-c to view. Those skilled in the art, will recognize that visualization of products and services shared by the group of members 102a-c through the use of pictures 114 may help facilitate payment, as consumers 102 are reminded of the collective benefit.

A web portion 412 connects members to the wireless network 106, such as the Internet. Members 102 may access popular social networks to further discuss and share the product, services, and subsequent payments thereof.

The system 100, 200 may also itemize each of the aforementioned functions in chronological sequence. For example, as shown in FIG. 4, a message sent by another member 102b displays. The message is followed by notification by the server 110 that payment was successfully received. The next function may include a request from another member 102 to join the network 106. Yet another function can be a notification that a payment was directed for a specific product or service. In one embodiment, the logo for the corresponding portion displays adjacent to the function.

FIG. 5 is a layout of a browser window 510 on a communication device 500 displaying a personalized view for a member 102. The personalized view requires the member 102 to log in, and can only be viewed by the respective member 102. The personalized view is effective for selectively networking and checking details on the bank account, such as account balance and recent transactions.

The personalized view may include a member identification portion 502 that provides information about the member 102. The information may include an image, a name, and membership history. A friend portion 504 is also available. The friend portion 504 comprises a list of other members 102b in the collective. The friend portion 504 may include the name and image of the member 102b. The friend portion 504 can be accessed to directly message a specific member 102b on any number of matters.

A bank account portion 506 displays the amount of funds in the bank account of the member 102. A transaction portion 508 itemizes and archives each payment or collection transacted with a specific member 102b. The account balance and transaction history in the bank account may also be accessible form the bank account portion 506. Additional functional availability from the payment portion 402 may include, without limitation, viewing dates of transactions, uploading a bill 108, viewing transaction history, and itemizing transactions, i.e., food, travel, utilities, etc. A password may be required to access the payment portion 402. In this manner, member 102 can better organize funds in the bank account, and better understand which members are paying, and which are nonpaying.

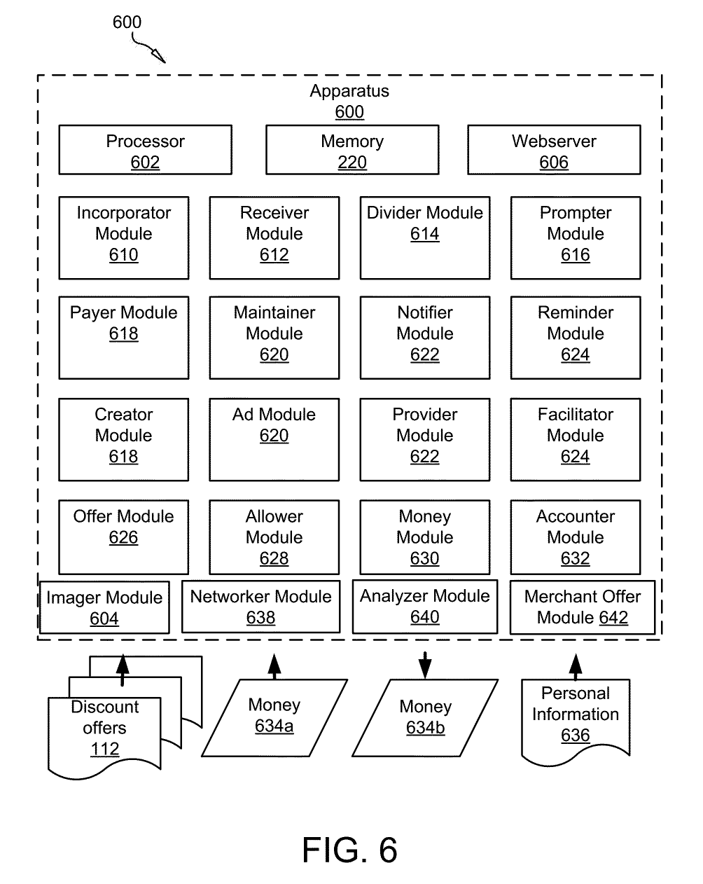

FIG. 6 is a block diagram illustrating components of one embodiment of an apparatus 600 for distributing expenses to commonly-acquainted members of a collective. The apparatus 600 comprises processor 602, a computer readable storage 220, webserver 606, an incorporator module 610, a receiver module 612, a divider module 616, a prompter module 616, a payer module 618, a maintainer module 620, a notifier module 622, a reminder module 626, a creator module 618, an ad module 620, a provider module 622, a facilitator module 626, an offer module 626, an allower module 628, a money module 630 an accounter module 632, an imager module 604, a networker module 638, an analyzer module 640, a merchant offer module 642, money 324a, money 634b, a discount offer 124, and personal information 636.

FIG. 6 may equally as well show a system embodiment of the present invention. Each of the modules, or components, of apparatus 600 may also comprise modules of a corresponding system 100, 200. The modules substantially perform the functions ascribed to method 300 steps disclosed hereinabove and below.

An incorporator module 610 is configured to incorporate a plurality of members 102a-c into a virtual collective by storing voluntarily uploaded personal information for each member 102 in computer readable memory, the personal information comprising one or more of name, email address, phone number, and banking information. When consumers 102 are incorporated by the system or apparatus 600, they upload personal information 636 to the server 110.

A receiver module 612 is configured to receive a payment request uploaded into computer readable memory from one member of the collective for an expense via a network.

An imager module 604 is configured to generate one or more of a picture that is pertinent to the expense via the wireless network, the pertinent picture uploaded into computer readable memory from one member of the collective for the expense incurred for the benefit of the collective.

A divider module 614 is configured to divide the expense pro rata among the members of the collective.

A prompter module 616 configured to prompt electronically via the network each member of the collective to pay a pro rata share of the expense.

A payer module 618 is configured to receive an electronic payment of a pro rata share from each of a plurality of the members of the collective.

A networker module 638 configured to enable networking among the members 102 of the collective to review the expense and the pertinent one or more of the pictures 114.

A maintainer module 620 is configured to maintain a running tally of payment amounts received from members 102 of the collective.

A notifier module 622 is configured to notify each member 102 via the network of the collective of the gross total of collective payments 212a received which are associated with the expense.

A reminder module 624 is configured to remind non-paying members of the user group to pay.

An analyzer module 640 is configured to analyze, by a merchant, the voluntarily uploaded personal information for each member, and the networking interactions among the members.

A merchant offer module 642 is configured to provide a discount offer 112 to the paying members 102 based on the analysis. In the shown embodiment, discount offers 112 are uploaded into the system 100, 200 or apparatus 600. Money 634a, or instructions to route money, are also uploaded by members of the collective into the apparatus 600, while aggregated money payments 634b may be sent from the system or apparatus 600 to members 102 of the collective who have paid for goods.

A creator 618 is module configured to create a sub-collective comprising a plurality of the members, each of the members of the sub-collective associated with one of: a common commercial venture and a common recreational activity.

An ad module 620 is configured to receive a classified ad from a member via an upload, the classified ad comprising one or more of a picture of a tangible good and contact information for the member, the contact information comprising one or more of name, email address, and telephone number.

A provider module 622 is configured to provide a searchable database of all classified ads received by members.

A facilitator module 624 is configured to facilitate the transfer of money between the member uploading the classified ad and a purchaser.

An offer module 626 is configured to receive a discount offer via an upload from a member, the discount offer comprising one or more of an offer to sell a consumer good exclusively to members, the offer comprising a price that is less than a price charged to non-members, the price exclusively available to members.

An allower module 628 is configured to allow members to purchase the consumer good for the price.

A money module 630 is configured to transfer money from a member 102a buying the consumer good to a member 102b responsible for the upload.

An accounter module 632 is configured to account for the money from a member 102 buying the consumer good to a member 102b responsible for the upload.

The functions of the systems shown in the present invention correspond generally to other systems, methods, apparatii and computer program products outlined in the present invention, and further illustrates the availability of different allocations of functionality amongst modules that implement an embodiment of the invention. To the extent that hardware, software, and firmware implementations are deemed partially or fully interchangeable at the time in question (now or hereafter) by one of skill in the art, they may be utilized in embodying the invention even though the specific implementation examples discussed here are different.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A non-transitory computer program product comprising a computer readable medium having computer usable program code executable to perform operations for distributing expenses to a commonly-acquainted collective, the operations of the computer program product comprising:
incorporating a plurality of commonly acquainted members into a virtual collective by storing voluntarily uploaded personal information for each member in computer readable memory, the personal information comprising name, email address, phone number, and banking routing information;
receiving a payment request and a description of an expense via a wireless network, the payment request uploaded into computer readable memory from one member of the collective for the expense incurred for the benefit of the collective;
generating one or more of a picture that is pertinent to the expense via the wireless network, the pertinent picture uploaded into computer readable memory from one member of the collective for access by the collective;
dividing the expense pro rata among the members of the collective;
prompting electronically via the network each member of the collective to pay a pro rata share of the expense;
sending a virtual bill via email to each member of the collective;
networking among the members of the collective to review the expense and the pertinent one or more of the picture;
receiving an electronic payment of a pro rata share from each of a plurality of the members of the collective, the electronic payment made from a virtual bank account exclusively associated with a member, the virtual bank account under control of a server prompting electronically the members to pay;
maintaining a running tally of payment amounts received from members of the collective, wherein a pro rata share of non-accepting member of the collective is redistributed to other members of the collective;
notifying each member via the network of the collective of the gross total of collective payments received which are associated with the expense;
reminding non-paying members of the user group to pay; and
analyzing, by a merchant, the voluntarily uploaded personal information for each member, and the networking interactions among the members; and
providing a discount offer to the paying members based on the analysis.

2. The computer program product of claim 1, further comprising remitting all payments received and associated with the expense to the member uploading the payment request.

3. The computer program product of claim 1, further comprising maintaining a banking account balance for each member of the collective, the balance exclusively accessible by a member of the collective associated with the balance.

4. The computer program product of claim 1, further comprising creating a sub-collective comprising a plurality of the members, each of the members of the sub-collective associated with one of: a common commercial venture and a common recreational activity.

5. The computer program product of claim 1, wherein the network comprises a wireless cellular network.

6. The computer program product of claim 1, wherein each of the members are notified via one of computer terminal and a smart cellular phone.

7. The computer program product of claim 1, further comprising:
receiving a classified ad from a member via an upload, the classified ad comprising one or more of the picture of a tangible good and contact information for the member, the contact information comprising one or more of name, email address, and telephone number;
providing a searchable database of all classified ads received by members; and
facilitating the transfer of money between the member uploading the classified ad and a purchaser.

8. The computer program product of claim 1, further comprising:
receiving the discount offer via an upload from a member, the discount offer comprising one or more of an offer to sell a consumer good exclusively to members, the offer comprising a price that is less than a price charged to non-members, the price exclusively available to members;
allowing members to purchase the consumer good for the price; and
transferring money from a member buying the consumer good to a member responsible for the upload.

9. The computer program product of claim 1, wherein each of the members is assigned a pay percentage value, the pay percentage value identifying the percentage of the expense for which each respective member is responsible.

10. A system to perform operations for distributing expenses to a commonly-acquainted collective, the system comprising:
a processor;
a data storage means for storing data;
an incorporator module configured to incorporate a plurality of members into a virtual collective by storing voluntarily uploaded personal information for each member in computer readable memory, the personal information comprising one or more of name, email address, phone number, and banking information;
a receiver module configured to receive a payment request uploaded into computer readable memory from one member of the collective for an expense via a network;
an imager module configured to generate one or more of a picture that is pertinent to the expense via the wireless network, the pertinent picture uploaded into computer readable memory from one member of the collective for the expense incurred for the benefit of the collective;
a divider module configured to divide the expense pro rata among the members of the collective;
a prompter module configured to prompt electronically via the network each member of the collective to pay a pro rata share of the expense;
a payer module configured to receive an electronic payment of a pro rata share from each of a plurality of the members of the collective;
a networker module configured to enable networking among the members of the collective to review the expense and the pertinent one or more of the picture;
a maintainer module configured to maintain a running tally of payment amounts received from members of the collective;
a notifier module configured to notify each member via the network of the collective of the gross total of collective payments received which are associated with the expense;
a reminder module configured to remind non-paying members of the user group to pay;
an analyzer module configured to analyze, by a merchant, the voluntarily uploaded personal information for each member, and the networking interactions among the members; and
a merchant offer module configured to provide a discount offer to the paying members based on the analysis.

11. The system of claim 10, further comprising a remitter module configured to remit all payments received and associated with the expense to the member uploading the payment request.

12. The system of claim 10, further comprising a creator module configured to create a sub-collective comprising a plurality of the members, each of the members of the sub-collective associated with one of: a common commercial venture and a common recreational activity.

13. The system of claim 10, wherein the network comprises a wireless cellular network.

14. The system of claim 10, wherein each of the members are notified via one of computer terminal and a smart cellular phone.

15. The system of claim 10, further comprising:
an ad module configured to receive a classified ad from a member via an upload, the classified ad comprising one or more of a picture of a tangible good and contact information for the member, the contact information comprising one or more of name, email address, and telephone number;
a provider module configured to provide a searchable database of all classified ads received by members; and
a facilitator module configured to facilitate the transfer of money between the member uploading the classified ad and a purchaser.

16. The system of claim 10, further comprising:
an offer module configured to receive a discount offer via an upload from a member, the discount offer comprising one or more of an offer to sell a consumer good exclusively to members, the offer comprising a price that is less than a price charged to non-members, the price exclusively available to members;
an allower module configured to allow members to purchase the consumer good for the price; and
a money module configured to transfer money from a member buying the consumer good to a member responsible for the upload.
